(19) United States
(12) Patent Application Publication
(10) Pub. No.: US 2006/0078862 A1
(43) Pub. Date: Apr. 13, 2006

(54) Answer support system, answer support apparatus, and answer support program

(75) Inventors: Kazuyuki Goto, Kanagawa (JP); Hideki Tsutsui, Kanagawa (JP); Sougo Tsuboi, Kanagawa (JP); Hiroshi Sasaki, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/180,575

(22) Filed: Jul. 14, 2005

(30) Foreign Application Priority Data
Sep. 27, 2004 (JP) P.2004-280142

(51) Int. Cl. G09B 7/00

(52) U.S. Cl. 434/322

(57) ABSTRACT

An answer support system includes an extracting unit to extract sentences of question made by a questioner, asking back of an answerer to the question, a reply of the questioner to the asking back, and an answer made by the answerer from a plurality of messages exchanged between the questioner and the answerer based on a reply relationship between the messages, a paragraph structure and sentence representation of each message, and a storing unit to store the extracted sentences in association with each other. In response to a new question, plural sets of sentences of question, asking back, reply, and answer stored in the past are searched for a set similar to a sentence of the new question, and a search result is presented in a manner that the sentences of question, asking back, reply, and answer are associated with the set similar to the sentence of the new question.

### CROSS-REFERENCE TO RELATED APPLICATIONS

This application is based upon and claims the benefit of priority from the prior Japanese Patent Application No. 2004-280142 filed on Sep. 27, 2004; the entire contents of which are incorporated herein by reference.

### BACKGROUND OF THE INVENTION

1. Field of the Invention

This invention relates to an answer support system, an answer support apparatus, and an answer support program and in particular to an answer support system, an answer support apparatus, and an answer support program for storing and making the most of past inquiry cases, thereby automatically presenting an appropriate answer to a customer's question and enabling the person in charge of an inquiry contact job to efficiently take appropriate steps.

2. Description of the Related Art

Hitherto, enterprises, stores, administrative agencies, educational facilities, medical institutions, etc., for providing products and services for customers have provided each an inquiry contact for accepting questions, complaints, demands, etc., from customers concerning products, services, etc., and take steps to deal with them. In the inquiry contacts called help desk, call center, customer support, etc., it is necessary to take appropriate and rapid steps for improving customer satisfaction, while laborsaving of the job is at stake. Hitherto, inquiries from customers have been made using means of telephones, facsimiles, etc., in recent years, inquiries from customers have been often made using means of electronic mail, predetermined forms provided at a Web site on the Internet, electronic bulletin board, chatting, etc., with the wide use of computers, mobile communication machines, and information networks.

In the inquiry contact job, for labor saving and efficiency, frequently asked cases, namely, sets of questions and answers, called FAQ (Frequently Asked Questions) are put into a database shared among the persons in charge of the inquiry contact job for reuse. Upon acceptance of a new question from a customer, the person in charge can search the database for a past question similar to the accepted question and reuse the answer to the question, thereby efficiently answering the question. A system for allowing a customer to enter a question directly in a database and search for an answer and a system for systematically arranging the sets of questions and answers for documentation and releasing the document to customers on a Web site, etc., are also realized. If it is made possible for a large number of costumers to solve their problems using such search services and documents, labor saving of the inquiry contact job can be accomplished. Hitherto, the person in charge of the inquiry contact job has often manually performed work of storing questions and answers in a database and systematically arranging the sets of questions and answers for documentation in an easy-to-inspect form, in recent years, a system for supporting work of storing and systematically arranging FAQ has also been designed.

An apparatus for reusing questions and answers made by electronic mail is proposed. (For example, refer to Japanese Patent No. 3,501,262.) From the past pieces of electronic mail exchanged in a mailing list, attention is paid to quotation and paragraph representation and a question sentence and its answer sentence are extracted. For mail of a new question, if a past mail question sentence similar to the question sentence exists, answer mail is automatically generated using the answer sentence paired with the past question sentence.

The similarity between the past question sentence and the hew question sentence is calculated based on the frequency of keyword appearing common to both the question sentences. This is a general technique in the field of natural language search and is widely used in processing of making search and classification based on the similarity between question sentences.

However, the amount of knowledge on the product, service, etc., about which questions are asked, the age, the occupation, and the like vary from one questioner of a customer, etc., using the inquiry contact to another and thus the terms, expression, description details, etc., of the question sentence written by each questioner vary from one questioner to another. Therefore, it is often impossible to appropriately calculate the similarity between a question sentence written by a different questioner in the past and a new question sentence. Consequently, for example, even if a past question sentence similar to the new question sentence exists, if they differ in meaning or context, an inappropriate answer is found, in contrast, since they differ in sentence although the questions have the same meaning, an appropriate answer cannot be found although a useful answer exists, this is a problem.

In addition to the method described in Japanese Patent No. 3,501,262, methods considering the sentence syntactic structure, paraphrase, synonym, etc., are also available as the method of calculating the similarity between question sentences. However, if syntax analysis is used, the accuracy of similarity calculation is not necessarily improved and it takes labor in providing a dictionary of paraphrase, synonyms, etc., for various products and services. Originally, information required for determining an answer is often insufficient in the question written by a questioner. If the question description of a customer is insufficient, the person in charge familiar with the inquiry contact job would be able to draw necessary information from the customer and lead to an answer by appropriately asking back to the customer.

On the other hand, if the customer searches for an answer using a document, search service, etc., on a Web site, such a help is not available and thus the customer often fails in searching for the answer.

Then, a system for previously associating additional information of choices, messages, etc., with information of FAQ and enabling the user to search for FAQ in an interactive mode using the information is proposed. (For example, refer to JP-A-2003-228575.) If the description of the first question is insufficient, the questioner selects the corresponding item from among the choices presented by the system, whereby detailed information is added to the question and the questioner can be led to the required answer. However, to realize such an interactive search, information of choices, messages, etc., needs to be previously created and the work of creating the information requires expert knowledge and labor.

On the other hand, if the person in charge of the inquiry contact job and the customer converse with each other to solve the problem, the less skilled person in charge of the inquiry contact job would be unable to efficiently lead the customer to an appropriate answer. In the inquiry contact job, expert knowledge and time tend to be required particularly for exchanging a customer's question and its check, confirmation, asking back, etc., between the person in charge and the customer. Thus, for example, erroneous asking back would cause both the questioner and the answerer to waste the time. Therefore, to make the job efficient, it is desirable that it should be made possible to efficiently store and reuse not only information on questions and answers, but also information on check, confirmation, asking back, etc., to lead the questioner to an answer.

According to the related arts described above, in the system in Japanese Patent No. 3,501,262, only the cases can be reused if an answer is returned directly to a question, namely, an answer is obtained in exchange of one question piece of mail and its answer piece of mail, this is a problem involved in the system in Japanese Patent No. 3,501,262. On the other hand, some systems in related arts record a series of pieces of information from a question to an answer as well as the question and the answer, for example, a history of all pieces of mail exchanged between each customer and each person in charge. However, if such histories are simply recorded without being systematically arranged, useful information and unuseful information are mixed and the effective use of information cannot be made, and for use as information that can be presented to the customer like choices as in JP-A-2003-228575, the history records are not appropriate in viewpoints of the contents, this is a problem.

It is therefore an object of the invention to make it possible to make an appropriate and efficient answer by reusing information provided when an answerer receiving a question of a questioner checks, confirms, and asks back to the questioner as required and also information of a reply of the questioner to the asking back. It is a further object of the invention to enable a questioner to search for an appropriate answer to a question using the asking back and reply information and solve a problem for himself or herself without help of an answerer.

### SUMMARY OF THE INVENTION

According to an aspect of the invention, there is provided an answer support system including an extracting unit configured to extract a sentence of question made by a questioner, a sentence of asking back of an answerer to the question, a sentence of a reply of the questioner to the asking back, and a sentence of an answer made by the answerer from a plurality of messages exchanged between the questioner and the answerer based on a reply relationship between the messages, a paragraph structure and sentence representation of each message, and a storing unit configured to store the extracted sentences of question, asking back, reply, and answer in association with each other. Preferably, in response to a new question, a plurality of sets of sentences of question, asking back, reply, and answer stored in the past are searched for a set similar to a sentence of the new question, and a search result is presented in a manner that the sentences of question, asking back, reply, and answer are associated with the set similar to the sentence of the new question.

According to another aspect of the invention, there is provided an answer support apparatus including a message transmission-reception section configured to transmit and receive a message exchanged between a questioner and an answerer, a message storage section configured to store the exchanged message, a case extraction section configured to extract data of a case to be reused from data of a message stored in the message storage section, a case extraction rule storage section configured to store a rule used for an extraction processing in the case extraction section, a case storage section configured to store case data extracted in the case extraction section in a predetermined type, and a case search section configured to search the case storage section for an appropriate case and to present the found appropriate case in response to a search request made by the questioner or the answerer.

According to another aspect of the invention, there is provided an answer support program for causing a computer for controlling an answer support system including a display, the method including extracting a sentence of a question made by a questioner, a sentence of asking back of an answerer to the question, a sentence of a reply of the questioner to the asking back, and a sentence of an answer made by the answerer from a plurality of messages exchanged between the questioner and the answerer based on a reply relationship between the messages, a paragraph structure and sentence representation of each message, storing the extracted sentences of question, asking back, reply, and answer in association with each other, in response to a new question, searching a plurality of sets of the sentences of question, asking back, reply, and answer stored in the past for a set similar to a sentence of the new question, and displaying a search result on the display in a manner that the sentences of question, asking back, reply, and answer are associated with the set similar to the sentence of the new question.

According to the invention, information of a question of the questioner, information of asking back of the answerer to the question, information of a reply of the questioner to the asking back, and information of an answer of the answerer are automatically extracted as a later reusable inquiry case from the messages exchanged between the questioner and the answerer, and are systematically arranged in association with each other for storage. Using the inquiry cases, even if the answerer is unskilled, the answerer can efficiently lead the questioner to an answer by making appropriate asking back and an answer to a new question of the questioner. The questioner can search for and inspect an appropriate answer to the question for himself or herself without help of the answerer, and it is made possible to drastically make efficient and save labor of the answer work to a question in an inquiry contact job, a network community, etc.

### BRIEF DESCRIPTION OF THE DRAWINGS

FIG. 1 is a drawing to show the configuration of an answer support system according to one embodiment of the invention;

FIG. 2 is a drawing to show an example of a message;

FIG. 3 is a drawing to show an example of a message;

FIG. 4 is a drawing to show an example of a message;

FIG. 5 is a drawing to show an example of a message;

FIG. 6 is a drawing to show an example of a message;

FIG. 7 is a drawing to show an example of a message;

FIG. 8 is a drawing to show an example of a message;

FIG. 9 is a drawing to show an example of a message;

FIG. 10 is a drawing to show an example of a message;

FIG. 11 is a drawing to show an example of a message;

FIG. 12 is a drawing to show an example of a message;

FIG. 13 is a drawing to show an example of a message;

FIG. 14 is a drawing to show an example of data of messages stored in a message storage section;

FIG. 15 is a drawing to show an example of a paragraph type determination rule;

FIG. 16 is a drawing to show an example of a sentence intention determination rule;

FIG. 17 is a drawing to show an example of a paragraph intention determination rule;

FIG. 18 is a drawing to show determination examples of paragraph type and sentence intention;

FIG. 19 is a drawing to show a data example of extracted cases;

FIG. 20 is a flowchart to show a flow of case extraction processing;

FIGS. 21A and 21B are flowcharts to show flows of processing of searching for a past case similar to exchange of question sentence and inquiry;

FIG. 22 is a drawing to show an example of a search screen for past cases similar to a question sentence;

FIG. 23 is a drawing to show an example of a screen where cases are edited;

FIG. 24 is a drawing to show an example of a search screen for past cases similar to a question sentence and an example of a screen presenting a sentence example of asking back;

FIG. 25 is a drawing to show an example of a search screen for past cases similar to inquiry exchange;

FIG. 26 is a drawing to show an example of a search screen for past cases similar to a question sentence and an example of a screen presenting details of answer;

FIG. 27 is a drawing to show an example of a search screen for past cases similar to a question sentence

FIG. 28 is a flowchart to show a processing flow of classifying cases and preparing a document; and

FIG. 29 is a drawing to show an example of a screen presenting a documented case.

### DETAILED DESCRIPTION OF THE INVENTION

Referring now to the accompanying drawings, there is shown an embodiment of the invention.

To begin with, one embodiment of the invention will be discussed.

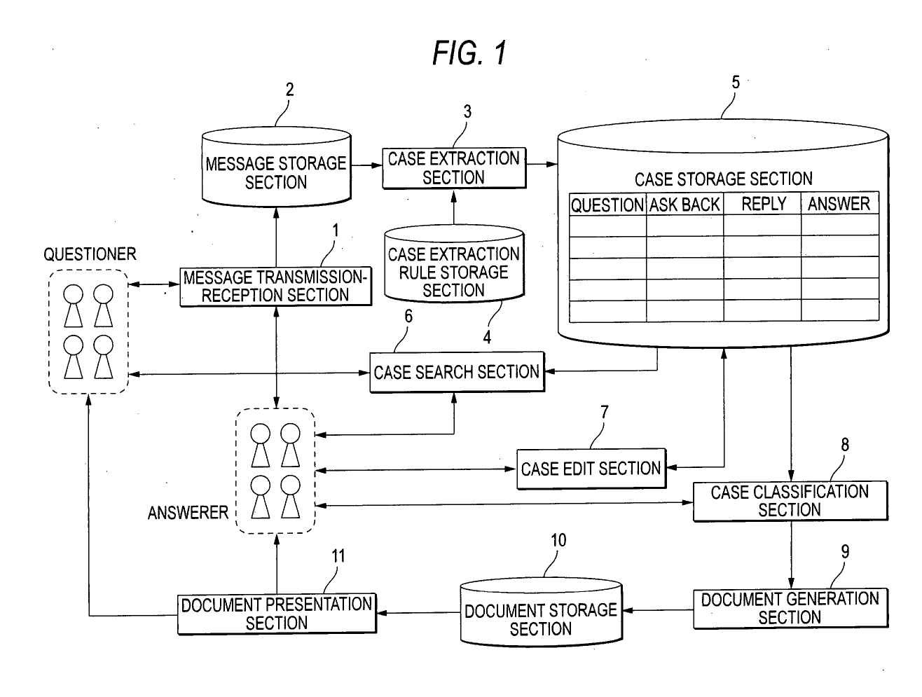

FIG. 1 is a drawing to show the configuration of one embodiment of an answer support system of the invention. In FIG. 1, numeral 1 denotes a message transmission-reception section for transmitting and receiving a message exchanged between a questioner and an answerer.

The message transmission-reception section 1 corresponds to electronic communication means of electronic mail, electronic bulletin board, chatting, etc., in related arts.

Using the message transmission-reception section 1, a questioner transmits a message of a question to an answerer, who then receives the question message and transmits an answer message to the questioner. Messages of asking back, check, confirmation, reply thereto, etc., are exchanged between the questioner and the answerer as required.

Numeral 2 denotes a message storage section for storing the data of the messages thus exchanged. Numeral 3 denotes a case extraction section and is a unit to automatically extract the data of the cases to be reused from the message data stored in the message storage section 2. The case extraction section 3 executes extraction processing based on a rule stored in a case extraction rule storage section 4. The case data extracted by the case extraction section 3 is stored in a case storage section 5 in a predetermined type described later. A case search section 6 is a unit to search the case storage section 5 for an appropriate case and to present the found appropriate case in response to a search request made by a questioner or an answerer.

The units 1 to 6 in FIG. 1 are indispensable component units in the embodiment of the invention and units 7 to 11 in FIG. 1 are included as additional units.

A case edit section 7 is provided for an answerer to edit the case data automatically extracted by the case extraction section 3 as required. In the case edit section 7, for example, work of deleting an unnecessary case, changing the case text to a more appropriate representation, making up for a shortage, etc., is performed.

A case classification section 8 is a unit to classify the cases stored in the case storage section 5 according to the classification method specified by the answerer. A document generation section 9 is a unit to generate a document by systematically arranging the cases stored in the case storage section 5 in an easy-to-inspect form. In the embodiment, a document conforming to the structure of classification created by the case classification section 8. A document storage section 10 is a unit to store the document generated by the document generation section 9. A document presentation section 11 is a unit to present the document stored in the document storage section 10 in response to a request made by a questioner or an answerer. The document storage section 10 and the document presentation section 11 correspond to a unit to perform services for storing and to present a document, such as a Web server in related arts.

As shown in FIG. 1, the unit that can be directly used by a questioner are the message transmission-reception section 1, the case search section 6, and the document presentation section 11. These units are designed so that they can be used by a plurality of questioners. As the most typical configuration, each questioner uses his or her terminal to connect to the answer support system of the invention through a network such as the Internet and receives support in the form of electronic mail, electronic bulletin board, Web service, etc.

On the other hand, each answerer also uses his or her terminal to connect to the answer support system for use, typically through an intranet. The unit that can be directly used by each answerer are the message transmission-reception section 1, the case search section 6, the case edit section 7, the case classification section 8, and the document presentation section 11. That is, unlike the questioner, the answerer can edit and classify the cases and is also authorized to directly inspect inquiry cases of questioners not directly covered by the answerer in some instances.

However, distinction between the questioner and the answerer on the use is not necessarily required in a use mode in which distinction between the questioner and the answerer is not clear, for example, in a use mode in which the members in a network community mutually are a questioner and an answerer.

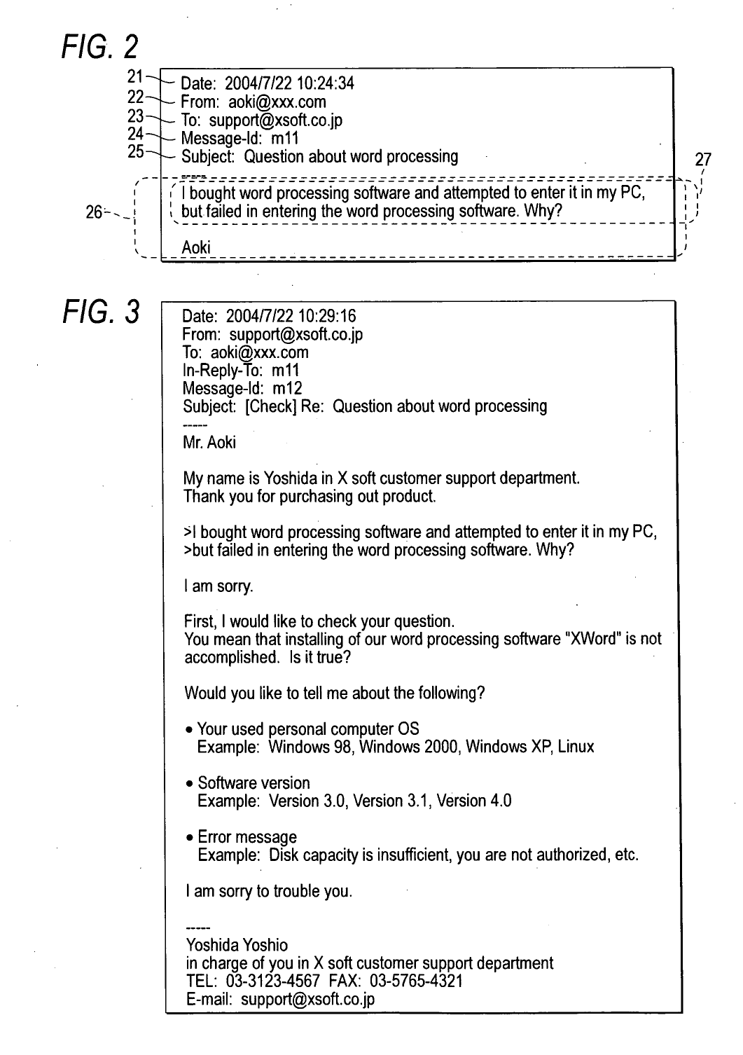

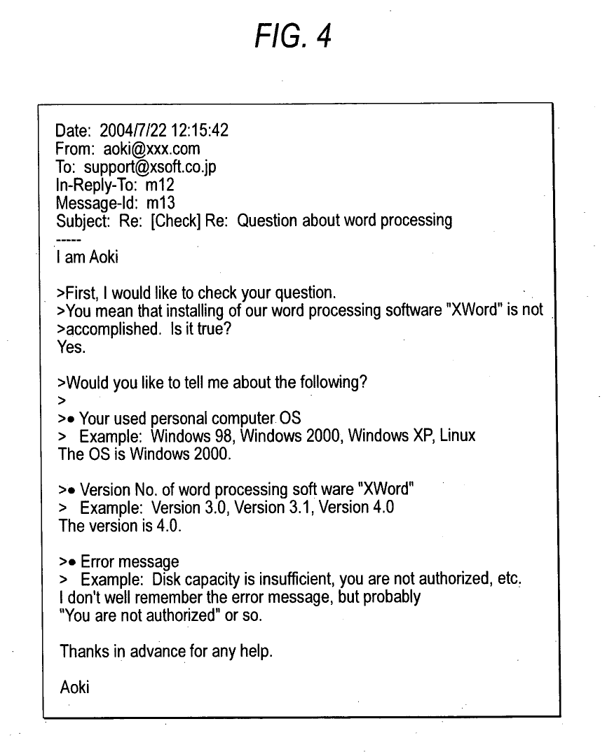

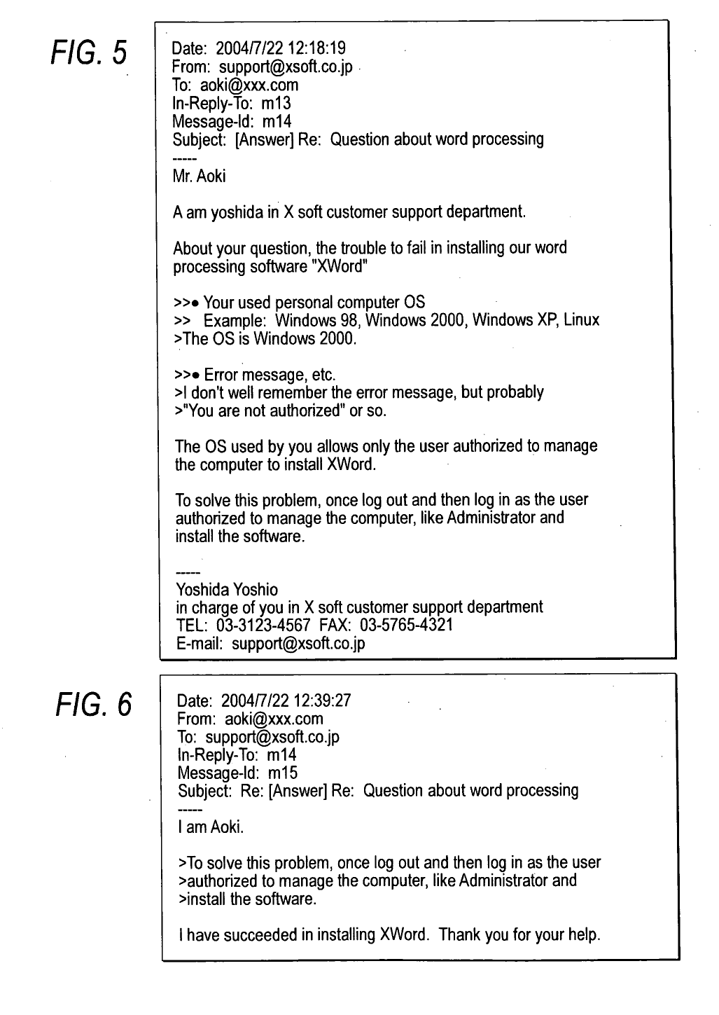

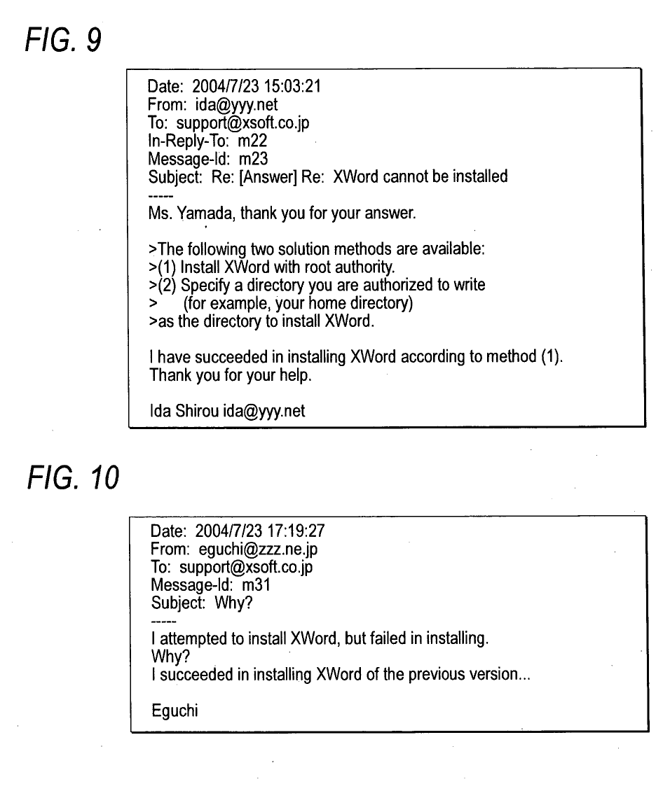

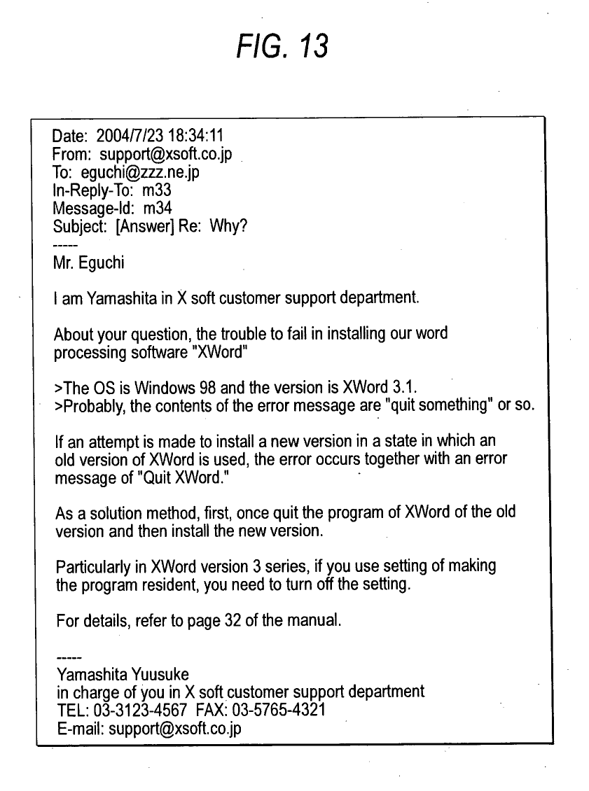

FIGS. 2 to 13 are drawings to show examples of messages exchanged between a questioner and an answerer. These drawings show examples of exchanging messages using electronic mail and the text shown in the drawings is electronic mail in itself. As data in electronic mail, data of mail date and time 21, a source address 22, a destination address 23, a unique message ID 24, a subject 25, etc, is described in a portion called a header as shown in 22, 23, etc., in FIG. 2. On the other hand, numeral 26 indicates a portion of the body of the message.

Numeral 31 in FIG. 3 indicates the ID of the message to reply to, and the reply relationship between the messages can be known based on the data. That is, the ID of the message to which the message in FIG. 3 replies is “m11” and therefore the reply to the message shown in FIG. 2 is the message in FIG. 3 (the message reply relationship is described according to “In-Reply-to” header field and “References” header field shown in the figure). In the reply message, often the sentence quoted from the former message is described as indicated in 32 in FIG. 3, and the quotation is often represented by a symbol of “>” or the like at the top of each line. The messages shown in FIGS. 2, 3, 4, 5, and 6 are associated with each other based on the reply relationship, a series of such messages is generally called message thread, simply thread.

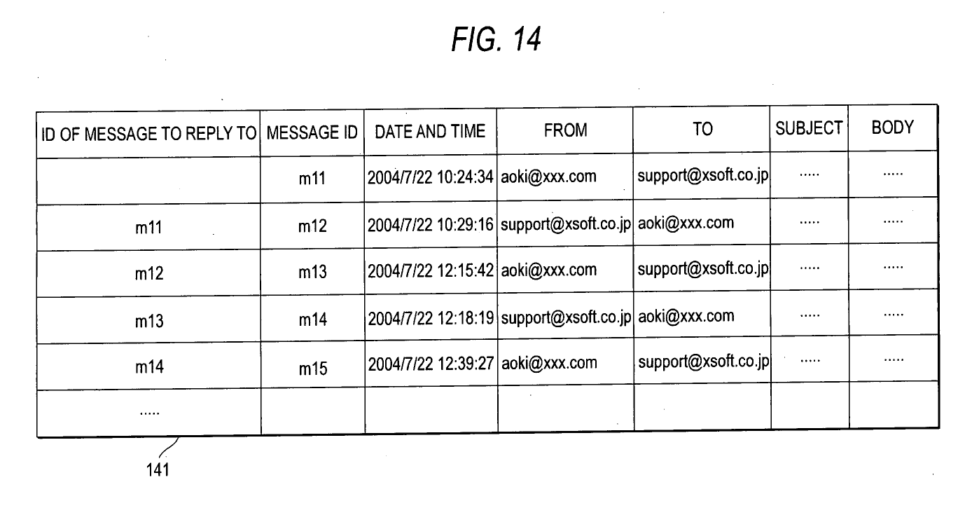

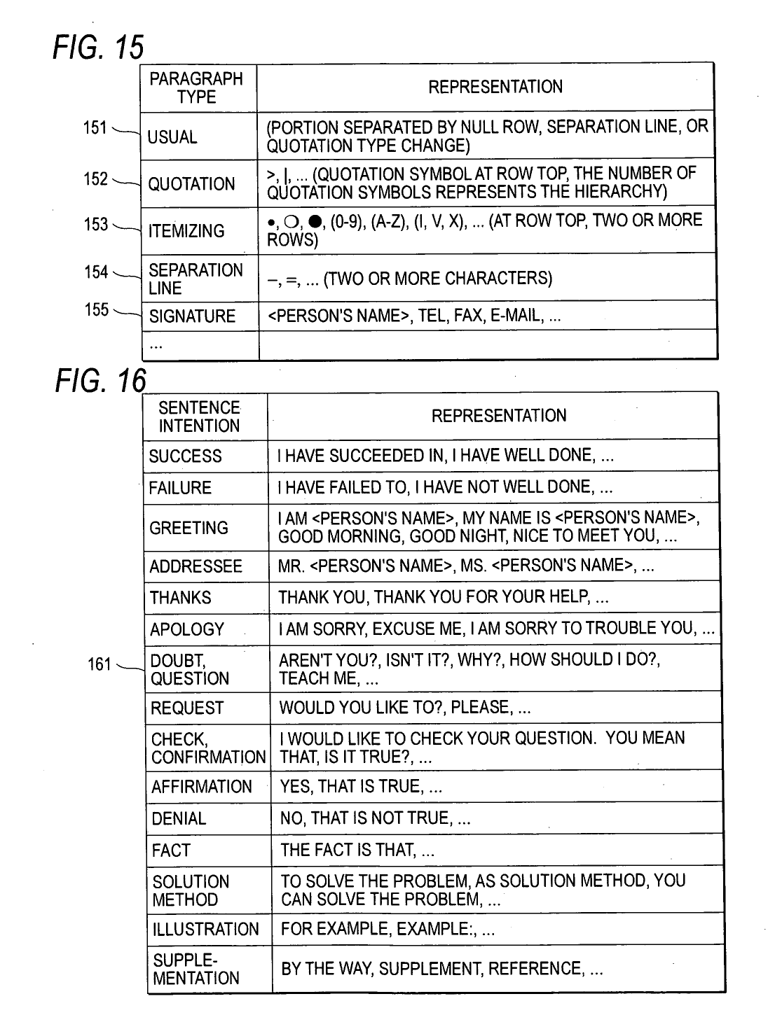

FIG. 14 is a drawing to show an example of the data stored in the message storage section 2. The data used with the answer support system according to the embodiment of the invention, of the data of the headers and the main bodies shown in FIGS. 2, 3, etc., is stored in the type shown in FIG. 14. For example, on a row 141, the message ID shown in FIG. 3 indicates the message “m12” and the fact that the ID of the message to which the message “m12” replies is “m11” is described. The messages with the message IDs “m11,” “m12,” “m13,” “m14,” and m15” correspond to the messages shown in FIGS. 2, 3, 4, 5, and 6 respectively, and these five messages form one thread, as described above.

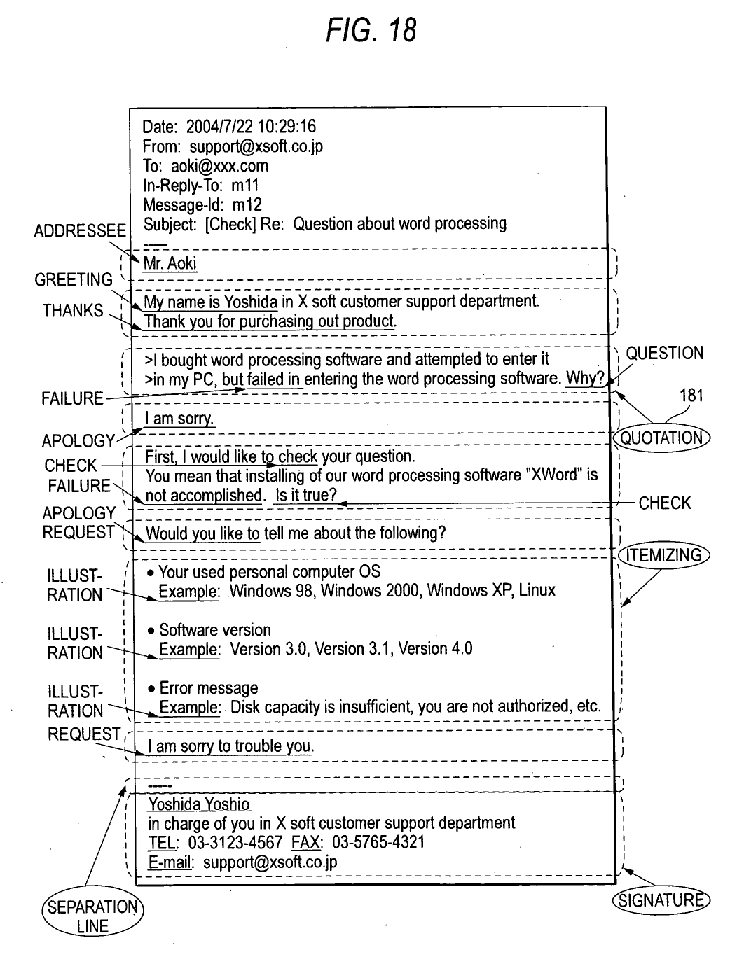

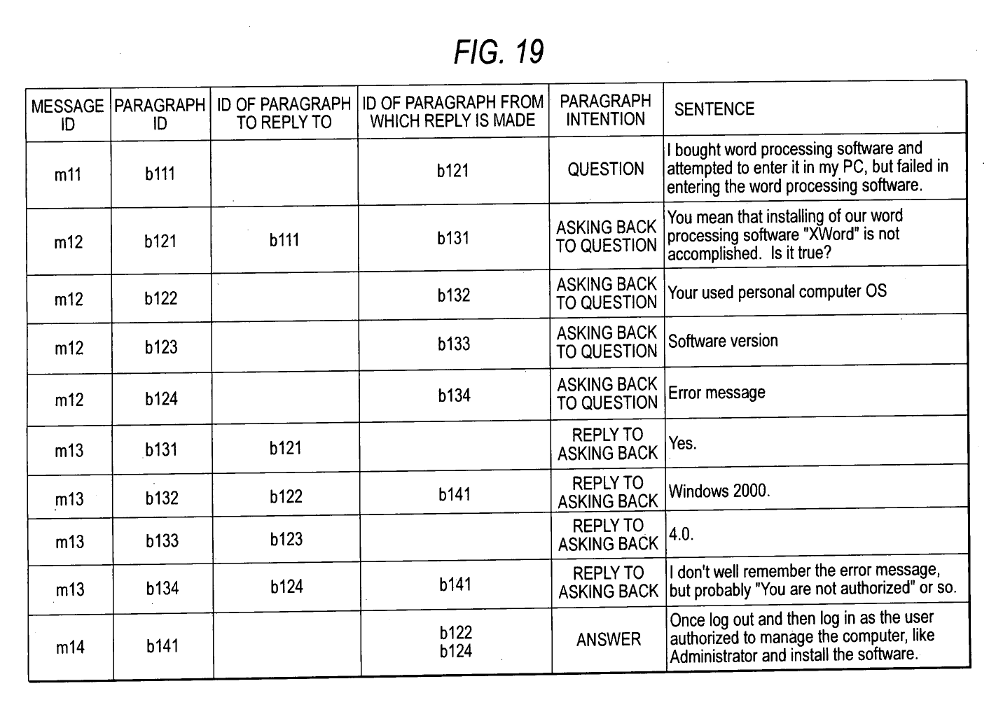

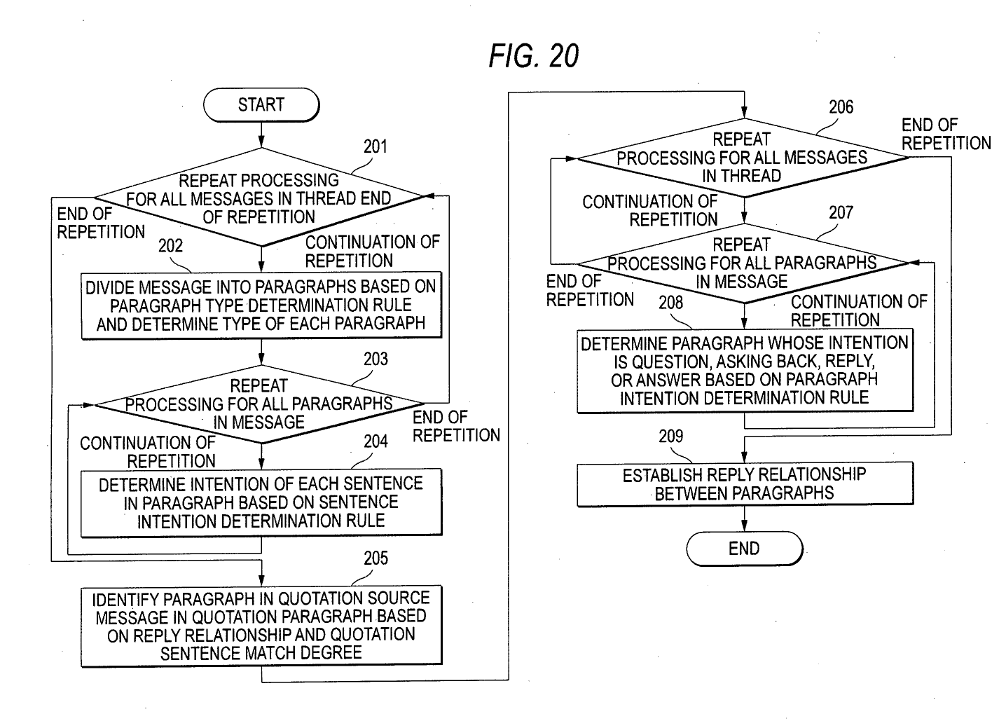

FIGS. 15, 16, and 17 are drawings to show examples of rules for extracting a case from messages. These rules are stored in the case extraction rule storage section 4. FIG. 20 is a flowchart to show a flow of processing of extracting a case from messages. FIG. 18 is a drawing to show an example of the determination result of the message paragraph type and the intention of each sentence. FIG. 19 is a drawing to show an example of the data finally extracted and stored in the case storage section 5 as the processing in FIG. 20 is performed.

Using the drawings, processing of extracting a case in a reusable form from messages will be discussed along the processing flow in FIG. 20. Since a case can be extracted separately for each thread, FIG. 20 shows a flow of processing performed for one thread. First, at step 201, steps 202 to 204 are repeated for all messages in the thread. At step 202, a message is divided into paragraphs based on the paragraph type determination rule shown in FIG. 15 and the paragraph type is determined for each paragraph. As shown in 151 in FIG. 15, usual paragraphs are divided by a null row, a separation line 154, a quotation type change row, etc. Quotation 152 is the most important element in the case extraction processing and is a paragraph type including a row containing a quotation symbol such as “>” at the beginning. If two to three quotation symbols lie in a row, it is determined a hierarchy of quotations, namely, a quotation from the message to reply preceding some paragraphs. Other paragraph types are itemizing 153, signature 155, etc.

After a message is divided into paragraphs at step 202 based on the described rule, for each paragraph (step 203), the intention of each sentence in the paragraph is determined based on a sentence intention determination rule (step 204). As shown in FIG. 16, the sentence intention determination rule is a rule for determining the intention of the sentence from the representation of the sentence. For example, it is determined that a sentence containing representation of “isn't it,” “?,” “why,” etc., has intention of doubt or question 161.

The determination processing may be performed based on surface representation of a sentence (expression of sentence) as to whether or not a certain character string appears as in the example or may be performed according to a method based on natural language processing of syntactic analysis, etc. If a slight determination error exists at the time of step 204, it can be corrected in the subsequent processing. FIG. 18 is a drawing to describe the result of the processing at steps 202 to 203 performed for the message shown in FIG. 3. As shown in FIG. 18, each message paragraph (portion surrounded by a dashed line), its type (“quotation,” “itemizing,” etc., enclosed with an ellipse), and the sentence intention in each paragraph (“greeting,” “thanks,” “check, confirmation,” etc.,) are determined.

Next, at step 205 in FIG. 20, the paragraph in the quotation source message in the quotation paragraph is identified based on the reply relationship between messages, namely, the relationship previously described with reference to FIG. 14 and the match degree of the quotation sentence with the quotation source message. For example, a quotation paragraph 181 in FIG. 18 corresponds to the paragraph in the message to reply to, namely, a portion 27 in FIG. 2 because the message is a reply to the message in FIG. 2 (with the message ID “m11”) and the sentence in the portion 181 matches the portion 27 in FIG. 2.

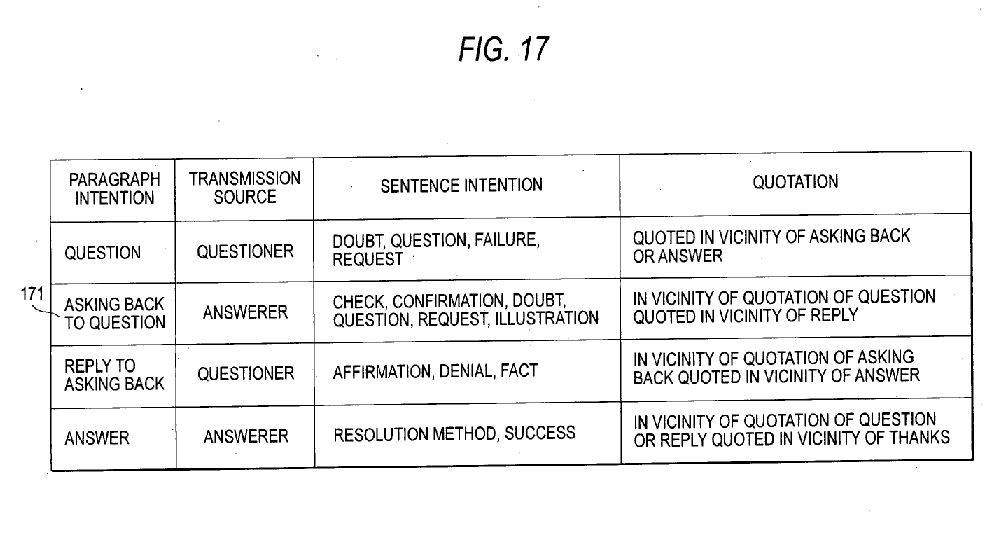

Next, step 208 in FIG. 20 is repeated for all paragraphs (step 207) of all messages in the thread (step 206). That is, the paragraph intention is which of “question of questioner,” “asking back of answerer to question,” “reply of questioner to asking back,” and “answer of answerer” is determined based on the paragraph intention determination rule shown in FIG. 17. As shown in FIG. 17, the intention is determined totally according to three conditions, namely, conditions of transmission source (questioner's message or answerer's message), sentence intention (as to whether or not sentence of predetermined intention such as doubt, question, check, confirmation, request, or resolution method is contained), and quotation (what the intention of paragraph or sentence quoted in the vicinity is or conversely paragraph is quoted in the vicinity of paragraph or sentence of what intention). For example, according to a condition 171 under which the paragraph is “asking back to question,” the possibility that a paragraph whose transmission source is “answerer” and which much contains sentences of intention “check, confirmation,” “doubt, question,” “request,” or “illustration” and is “in the vicinity of quotation of question” and “quoted in the vicinity of reply” may be “asking back to question” is high. Only the condition about the transmission source, of the three conditions is indispensable and the sentence intention and quotation conditions need not necessarily be satisfied. For example, a method may be used wherein whenever one condition is satisfied, a point (sureness) is added and the paragraph with the highest score is selected (therefore, as described above, if determination of the intention of each sentence contains an error, the possibility that the intention of the paragraph will be determined totally correctly is high). In the embodiment of the invention, the determination method is not limited. As the result of the processing at step S208, each paragraph is determined corresponding to “question of questioner,” “asking back of answerer to question,” “reply of questioner to asking back,” or “answer of answerer” as shown in FIG. 19. Each paragraph is assigned a unique ID and at step 209, the reply relationship between the paragraphs is established. That is, for example, the paragraph with paragraph ID b121 (asking back) is asking back to paragraph b111 (question) and further paragraph b131 (reply) is a reply to the paragraph b121. The data thus extracted is stored in the case storage section 5.

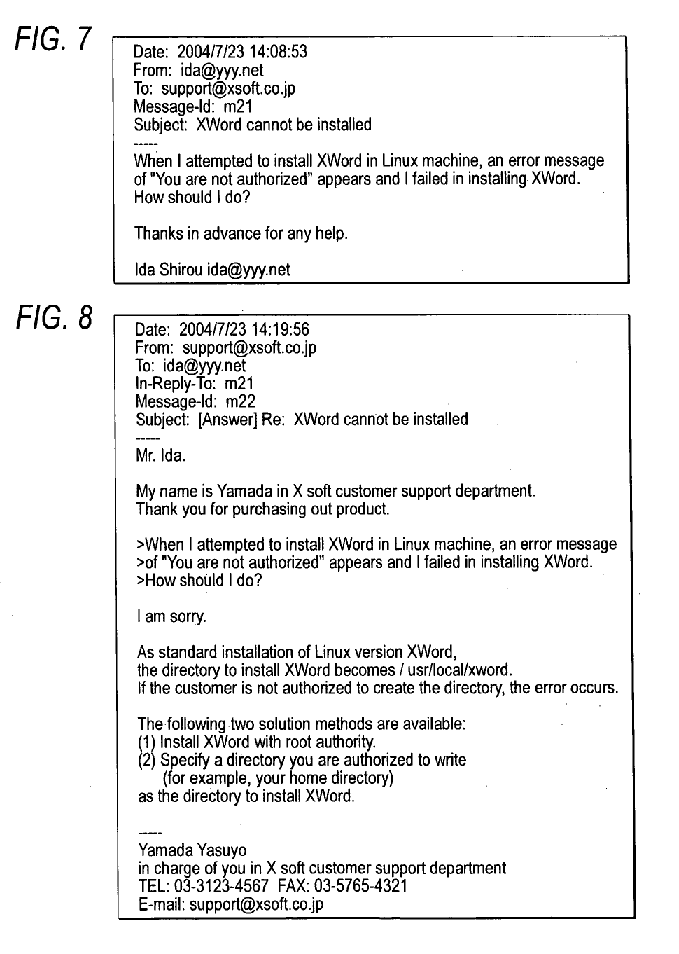

The case extraction processing in the embodiment of the invention has been described by taking as an example the case where question, asking back, reply, and answer messages are transmitted and received one at a time as the messages exchanged from a question to an answer. However, appropriate extraction is also conducted in the case where an answer is returned directly to the question with asking back omitted as shown in FIGS. 7, 8, and 9 and conversely in the case where asking back, reply, and the like are exchanged two or more times each with a plurality of messages. The case extraction processing has been described based on the example wherein the number of questioners is one and the number of answerers is one. However, the numbers of questioners and answerers may be each two or more.

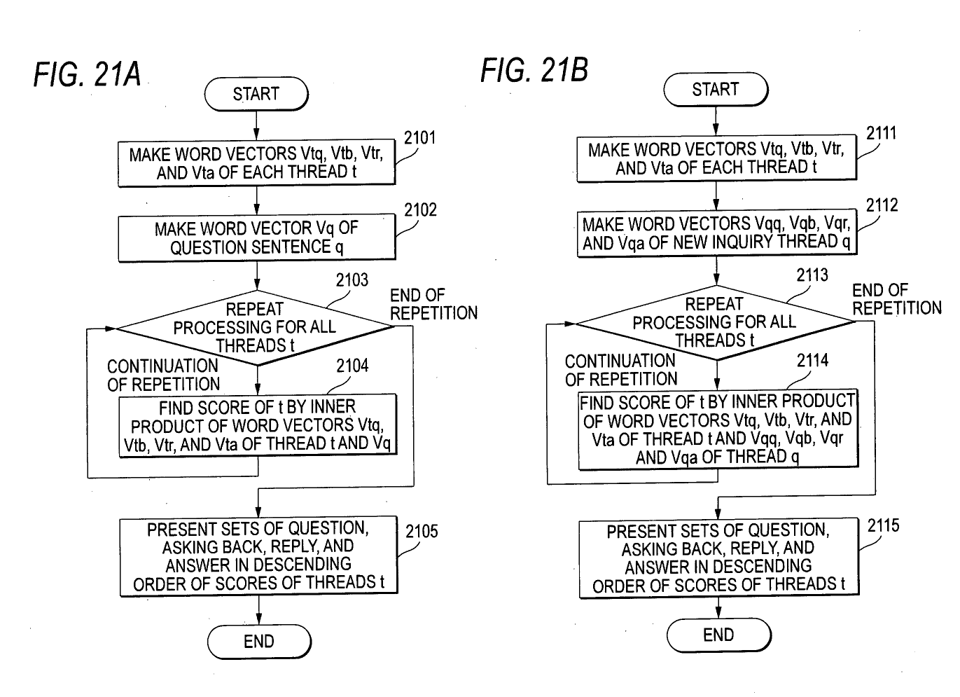

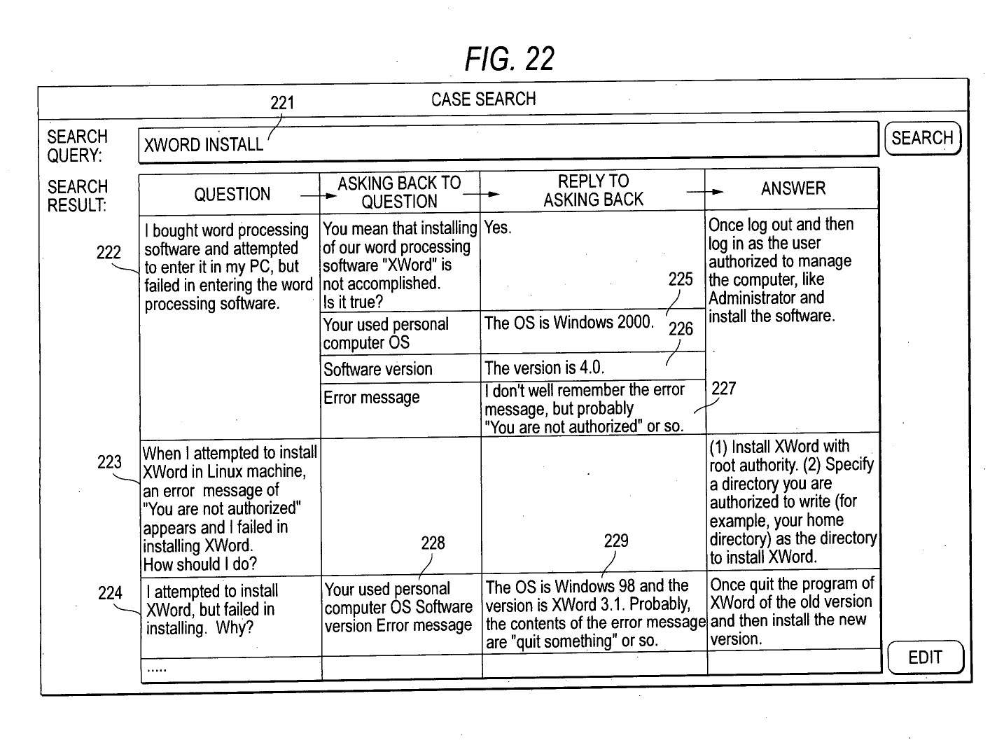

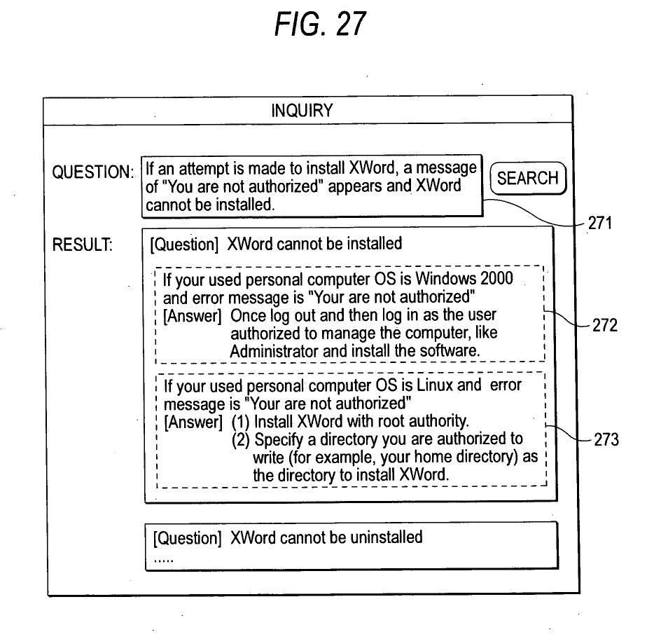

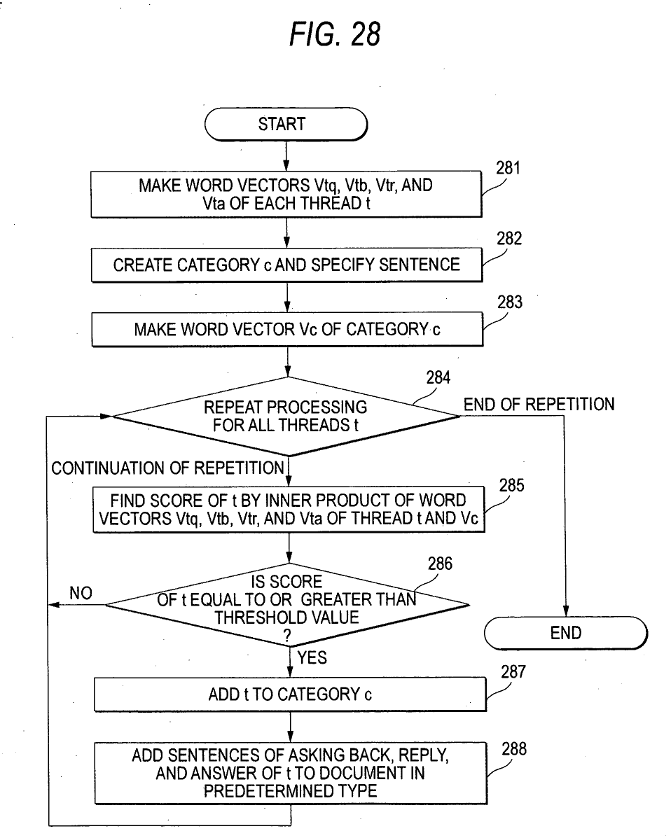

FIGS. 22 to 27 are drawings to show examples of search screens of the past cases stored in the case storage section 5. FIGS. 22 to 25 show examples of the screens used by an answerer, and FIGS. 27 and 28 show examples of the screens used by a questioner. FIGS. 21A and 21B are flowcharts each to show a flow of case search processing performed by the case search section 6. FIG. 21A shows processing of searching for a past similar case if a question sentence (natural language sentence or keyword) is given as a search query. On the other hand, FIG. 21B shows processing of searching for a past similar case if message exchange is given as a search query.

The search processing in the embodiment of the invention will be discussed below with the drawings.

To begin with, at step 2101 in FIG. 21A, word vectors Vtq, Vtb, Vtr, and Vta are made about sentences of question tq, asking back tb, reply tr, and answer ta determined according to the above-described method for each message thread t. The word vector is as follows. Each word appearing in a sentence is related to each dimension and the sentence is modeled based on the vector weighted according to TF-IDF, etc., based on the frequency for each word, the technique is a general technique called vector space model in document search. The TF-IDF weighting is defined by occurrence frequency or TF (Term Frequency) of the word in one sentence, the number of sentences, and the number of sentences in which the word occurs once or more, IDF (Inverse Document Frequency). To select each word, a method of selecting autonomous words obtained by morphological analysis, for example, is available. In the morphological analysis, a sentence written in a natural language is divided into a string of morphemes (roughly speaking, words) and parts of speech are determined.

Step 2101 in FIG. 21A is equal to step 2111 in FIG. 21B and step 281 in FIG. 28 and therefore these steps are previously executed before actual search, for example, when a case is stored in the case storage section 5. Next, at 2102 in FIG. 21A, word vector Vq of question sentence q of a search query is made. The method of finding the word vector Vq is the same as the method of finding the word vector Vtq from the question tq, for example. Next, the processing is repeated for all threads t (step 2103) and the score of the thread t is found by the inner product (or cosine) of Vtq, Vtb, Vtr, Vta and Vq (step 2104). This processing is also based on vector space model. Here, the weight of each vector is added as in expression (1) in response to the paragraph intention. Stq is the score, wq, wb, wr, and wa are each a weight, and “·” is the inner product (or cosine) of the vectors.
Stq=(wqVtq+wbVtb+wrVtr+waVta)·Vq Expression (1)

At this time, it is considered that thread t with the question tq and the reply tr in the thread having a larger number of words common to the question sentence q has large relation with the question sentence and therefore the weights wq and wr are made large as compared with wb and wa so that the score of the thread becomes large. In the search processing, a search is made for the sentences of a summary of the thread rather than all sentences of the thread, so that the search relevance ratio is raised. After the score of each thread is thus found, sets of question tq, asking back tb, reply tr, and answer ta are presented as the search result in the descending order of the scores of the threads t at step 2105.

FIG. 22 is a drawing to show an example of a search screen for past cases similar to a question sentence. It shows the search result when the operator specifies a search query 221 with two keywords “XWord” and “install” and clicks on a search button placed in the upper right corner of the screen for searching for the past cases. Sets of question, asking back to question, reply to asking back, and answer as shown on rows of 222, 223, and 224 are presented as the search result. This screen is an example of a search screen used by the answer in charge of the inquiry contact job. As shown in the figure, the messages as shown in FIGS. 2 to 13 are presented briefly and in such a manner that the answerer can easily keep track of the exchange process. The row 223 corresponds to the message inquiry case shown in FIGS. 7, 8, and 9, it is the case with no asking back and no reply to asking back, and the corresponding columns become blank. The case extraction processing previously described with reference to FIG. 20 is processing automatically performed and whether or not the processing is performed appropriately also depends on the sentence description of each message. Thus, the extraction result does not necessarily become the best sentence in the easy-to-reuse point, but the answerer can use the case edit section 7 to edit the edit result (sentence) to an appropriate sentence. To do this, in the screen example shown in FIG. 22, the answerer clicks on an edit button placed in the lower right corner of the screen and edits the edit result (sentence).

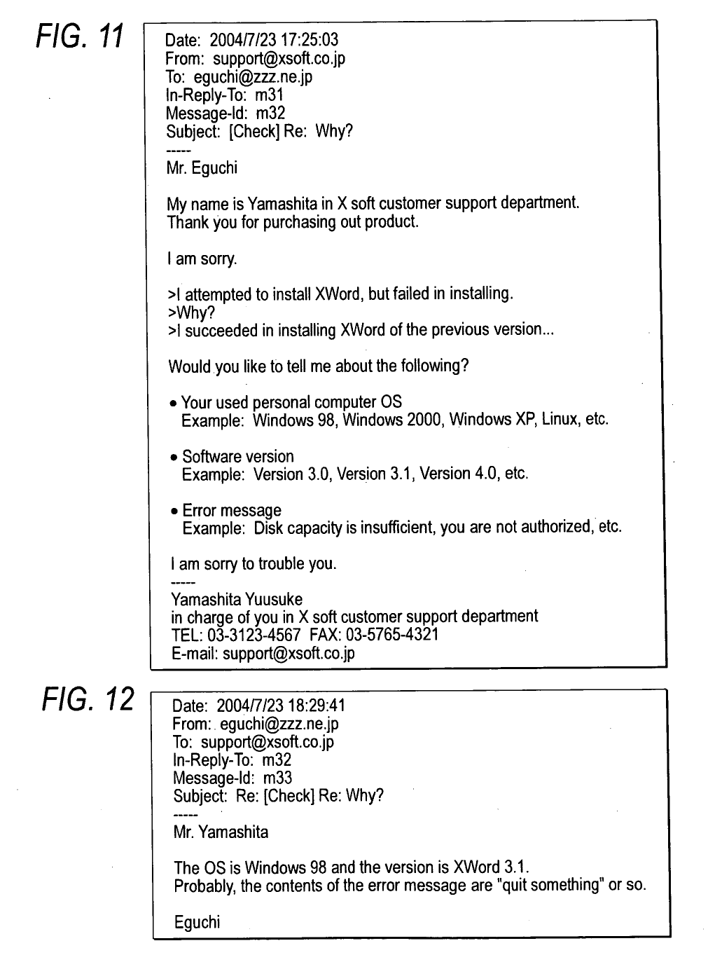

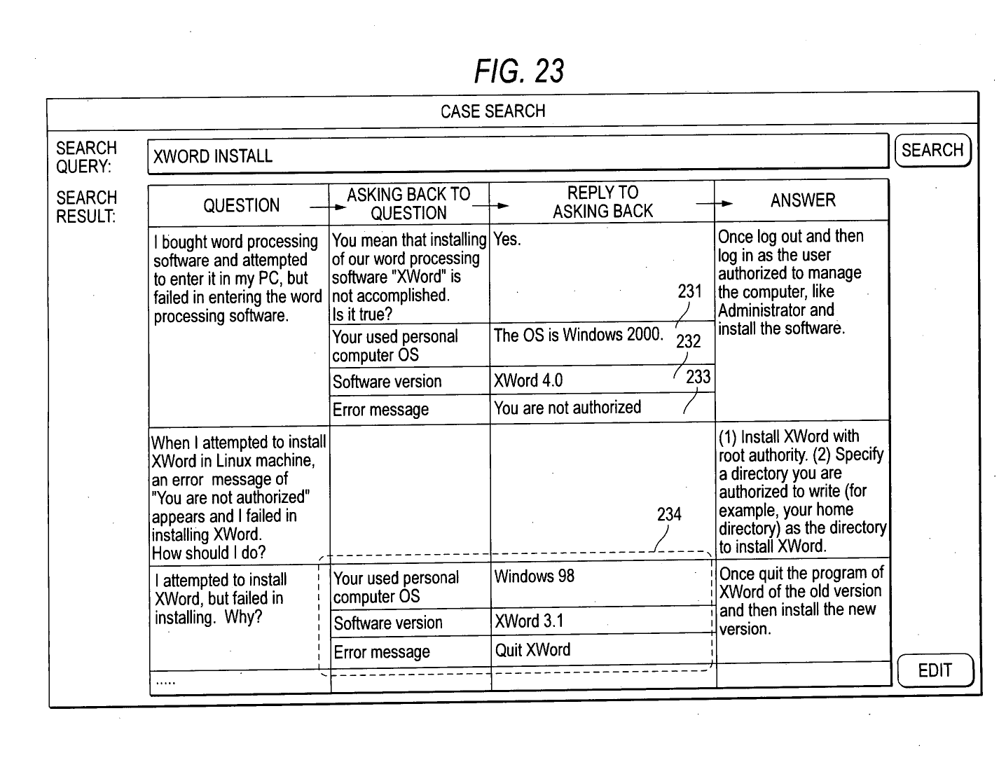

FIG. 23 is a drawing to show an example of a screen where parts of 225, 226, 227, 228, and 229 in FIG. 22 are edited. The edit unit can be used to make the sentence representation precise and delete unnecessary parts (231, 232, and 233 in FIG. 23). For example, in the reply to the message of asking back shown in FIG. 11, if it is difficult to automatically separate reply items corresponding to items of asking back as shown in FIG. 12, the reply can be arranged so that it is easily reused, as shown in 234 in FIG. 23.

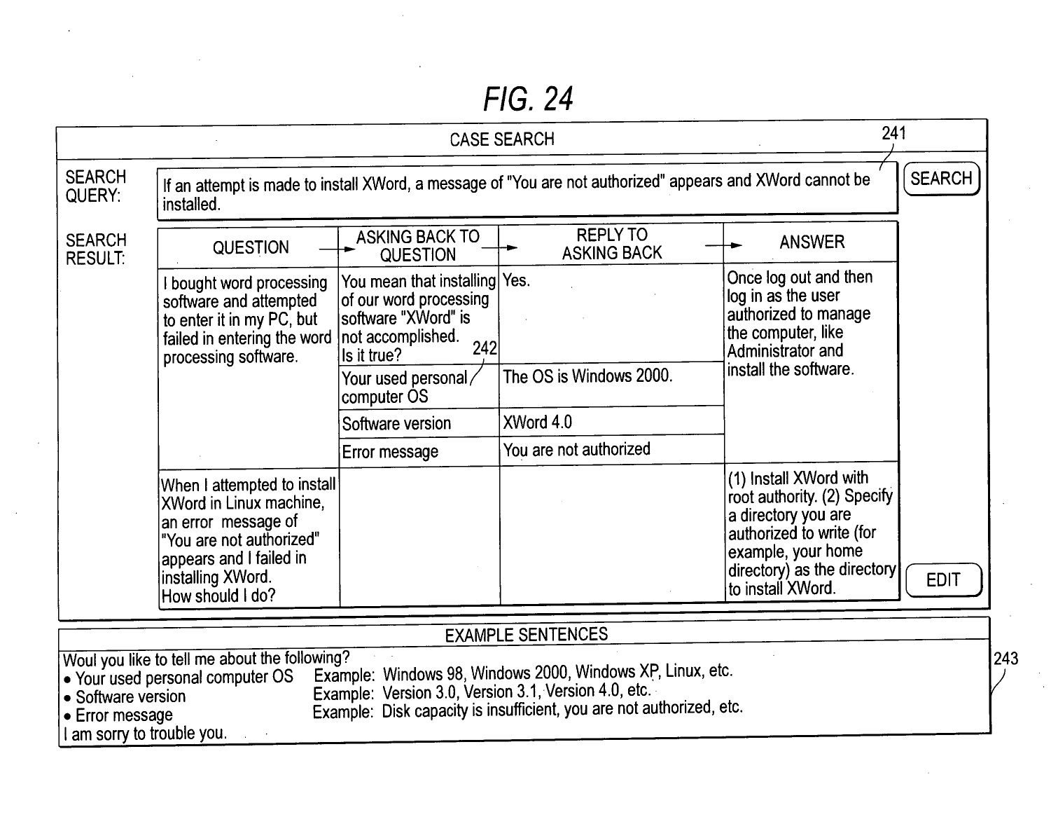

FIG. 24 is a drawing to show a screen example of the search result when a question 241 of a comparatively long natural sentence is used as a search query. Appropriate cases are narrowed down and are displayed based on the words of “authorized” and “message” contained in the question. If the answerer finds a sentence to be reused particularly in referencing the search result, the answerer is enabled to immediately inspect the message corresponding to the sentence. For example, if the answerer wants to reuse the example sentence of asking back in a box 242 in FIG. 24, the answerer can display the detailed sentences in the box on a screen as in 243 in FIG. 24.

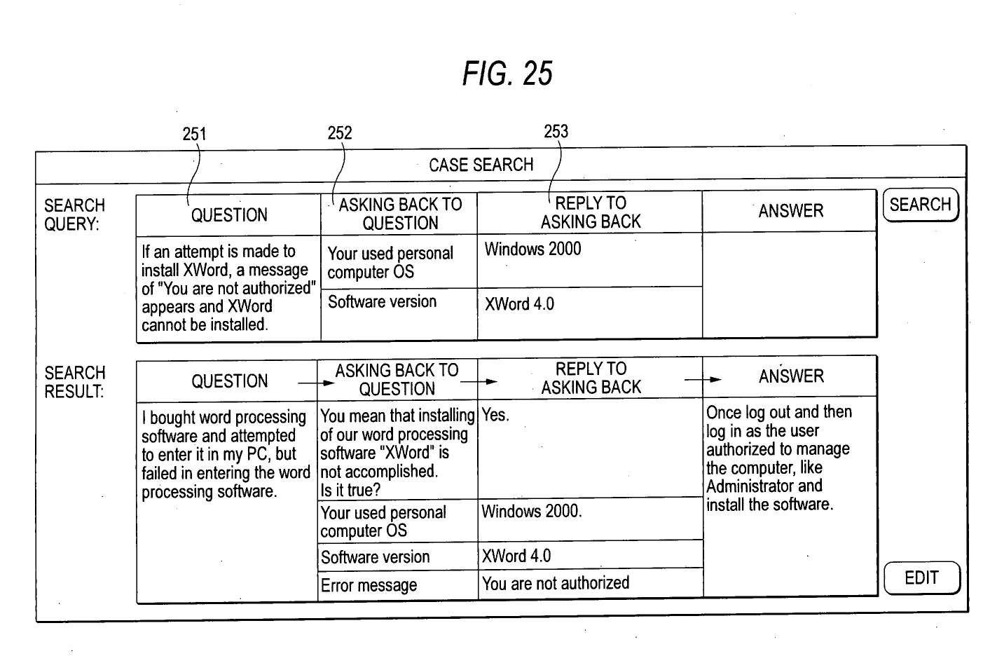

One of the features of the invention is that not only a search is made for cases using a question statement as a search query, but also an appropriate and easy search can be made for cases similar to the inquiry case at various stages of the message exchange between the answerer and the questioner. FIG. 21B is a flowchart to show a flow of the processing. FIG. 25 is a drawing to show an example of a search screen for past cases similar to inquiry exchange. FIG. 21B is similar to FIG. 21A, since the search query is message exchange, namely, thread, at step 2112, the sentences of question qq, asking back qb, reply qr, and answer qa in thread q are extracted according to the processing previously described with reference to FIG. 20 and then word vectors Vqq, Vqb, Vqr, and Vqa are made. Since the thread q is a thread in which inquiry exchange continues, often an answer is not yet obtained and often qa does not exist (Vqa is null). At step S2114, the score of t is found as the inner product (or cosine) of the q vectors and the vectors of each past thread t. Calculation for finding the score from the vectors of the threads q and t may be performed according to the following expression (2) with weights added as with the above-described method.
Stq=(wqVtq+wbVtb+wrVtr+waVta)·(wqVqq+wbVqb+wrVqr+waVqa) Expression (2)

The processing at step 2114 is repeated for all threads t (step 2113).

FIG. 25 shows a search screen example for cases using a thread as a search query. A search is made for an appropriate case totally similar to question 251, asking back to question 252, and reply to asking back 253 extracted from the exchange made so far between the questioner and the answerer.

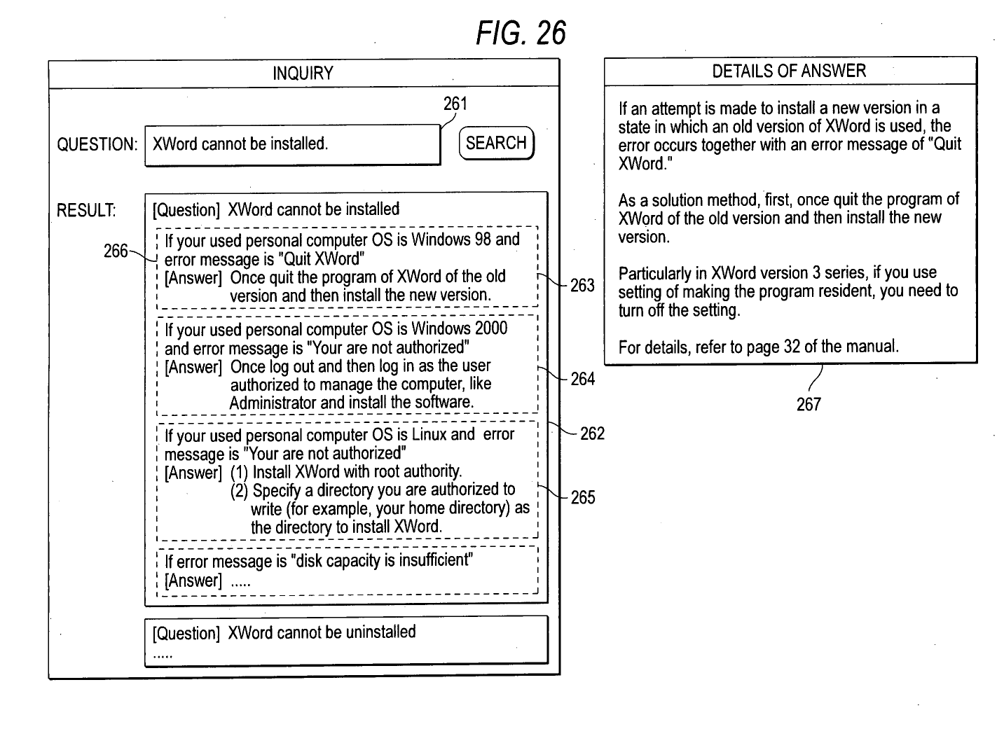

FIGS. 26 and 27 are drawings each to show a screen example for a questioner to use the search function of the answer support system according to the invention to search for an answer. One of the features of the invention is that an appropriate answer is presented in an easy-to-understand form using information of asking back and reply contained in each case.

The example in FIG. 26 is an example wherein answers relevant to the question statement with slightly insufficient detailed information are appropriately classified. The answers first are grouped and presented for each category as shown in 262 (a method of creating the categories is described later). Further, each answer 263, 264, 265 is presented with a sentence 266 for explicitly indicating the case where the answer is effective. The sentence like 266 is generated in the form of “if ** is XX” using the sentences of asking back and reply described above (231, 232, 233 in FIG. 23). The questioner reads the sentence, whereby he or she can easily find out any desired answer, select only detailed answer, and inspect the answer in the form of details of answer in 267 and can also be prevented from using an unuseful answer or an erroneous answer.

FIG. 27 shows a search result screen example like FIG. 26, in the example in FIG. 27, a question sentence is described in more detail than that in the example in FIG. 26, whereby more appropriate answers only are displayed as the search result.

FIG. 28 is a flowchart to show processing of classifying the past cases stored in the case storage section 5 and further preparing a document from the classification result. The processing is performed by the case classification section 8 and the document generation section 9. The document generated as the result of the processing is stored in the case storage section 5 and is presented by the document presentation section 11 in response to a request made by a questioner or an answerer.

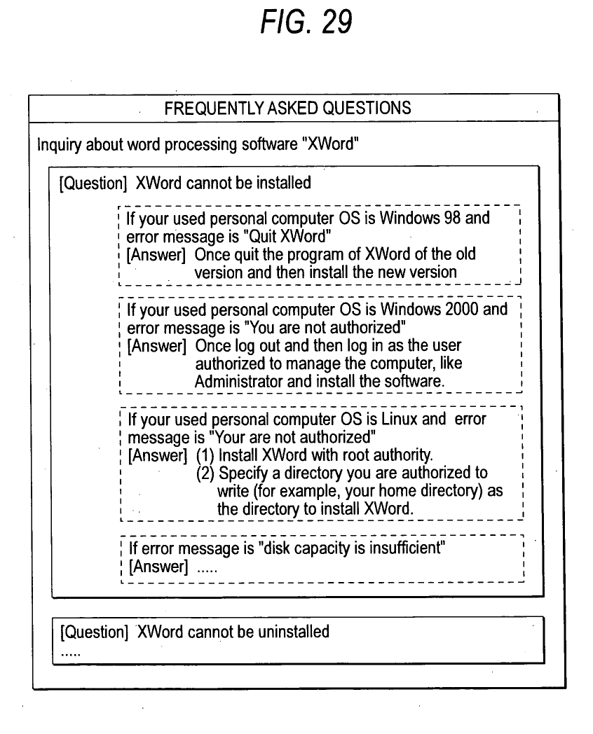

FIG. 29 is a drawing to show an example of the presented document.

In the examples of the search result shown in FIGS. 26 and 27, the search result is grouped and is presented for each category as described above. The category creation processing is also almost the same as the processing described with reference to FIG. 28 (only step 288 is unnecessary). The classification processing in FIG. 28 is similar to the search processing in FIG. 21, and step 281 is the same as step 2101. At step 282, first the answerer creates an empty category and sets a sentence of “XWord cannot be installed,” for example, as the sentence representing the meaning of the category. The sentence is equal to the question sentence q in FIG. 21A. The score of thread t is found by the inner product (or cosine) of word vector Vc created from the sentence (step 283) and each thread t (step 285). Thread having the score equal to or greater than a threshold value (step 286) is added to the category c (step 287). In the document generation section 9, the sentences of asking back, reply, and answer of t are added in a predetermined type, whereby the sentence for the category c can be created. If the work is repeated as many times as the necessary number of categories, a necessary document can be created.

Clustering cases can also be easily accomplished according to a similar concept to the classification processing, because the cases are represented as sets of sentences of question, asking back, reply, and answer and the sentences can be automatically extracted and further the similarity among the cases is defined according to the embodiment of the invention. For example, to release documents of search service and question-answer cases to general customers, presenting inquiry cases of other customers without any edit often involves a problem from the viewpoints of the contents and protection of personal information. In this case, the answerer, namely, the person in charge of the inquiry contact job may search for and present only the appropriately edited cases using the case edit section 7 as described above.

It is to be understood that the invention is not limited to the specific embodiment and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. An answer support system comprising:
an extracting unit configured to extract a sentence of question made by a questioner, a sentence of asking back of an answerer to the question, a sentence of a reply of the questioner to the asking back, and a sentence of an answer made by the answerer from a plurality of messages exchanged between the questioner and the answerer based on a reply relationship between the messages, a paragraph structure and sentence representation of each message; and
a storing unit configured to store the extracted sentences of question, asking back, reply, and answer in association with each other, wherein
in response to a new question, a plurality of sets of sentences of question, asking back, reply, and answer stored in the past are searched for a set similar to a sentence of the new question, and
a search result is presented in a manner that the sentences of question, asking back, reply, and answer are associated with the set similar to the sentence of the new question.

2. The answer support system as claimed in claim 1, wherein
the storing unit is searched for a past set of sentences of question, asking back, reply, and answer similar to one or more of the sentences of question, asking back, reply, and answer extracted by the extracting unit from a plurality of new messages exchanged between the questioner and the answerer, and a search result is presented in a manner that the sentences of question, asking back, reply, and answer are associated with the past set of sentences.

3. The answer support system as claimed in claim 1, further comprising:
a classifying unit configured to classify a plurality of sets of the sentences of question, asking back, reply, and answer stored in the storing unit into sets similar to each other.

4. The answer support system as claimed in claim 1, wherein
a document is generated using sentences from the plurality of sets of sentences of question, asking back, reply, and answer stored in the storing unit.

5. An answer support apparatus comprising:
a message transmission-reception section configured to transmit and receive a message exchanged between a questioner and an answerer;
a message storage section configured to store the exchanged message;
a case extraction section configured to extract data of a case to be reused from data of a message stored in the message storage section;
a case extraction rule storage section configured to store a rule used for an extraction processing in the case extraction section;
a case storage section configured to store case data extracted in the case extraction section in a predetermined type; and
a case search section configured to search the case storage section for an appropriate case and to present the found appropriate case in response to a search request made by the questioner or the answerer.

6. The answer support apparatus as claimed in claim 5, further comprising:
a case edit section configured to edit the case data extracted in the case extraction section;
a case classification section configured to classify a plurality of cases stored in the case storage section according to a classification method specified by the answerer;
a document generation section configured to generate a document systematically arranged from the cases stored in the case storage section;
a document storage section configured to store the document generated in the document generation section; and
a document presentation section configured to present the document stored in the document storage section in response to a request made by the questioner or the answerer.

7. The answer support apparatus as claimed in claim 5, wherein
the rule used for the extraction processing stored in the case extraction rule storage section enables a sentence of any of a question, asking back, a reply, or an answer to be extracted based on a reply relationship between the messages, a paragraph structure and sentence representation of each message.

8. An answer support program for causing a computer for controlling an answer support system including a display, the method comprising:
extracting a sentence of a question made by a questioner, a sentence of asking back of an answerer to the question, a sentence of a reply of the questioner to the asking back, and a sentence of an answer made by the answerer from a plurality of messages exchanged between the questioner and the answerer based on a reply relationship between the messages, a paragraph structure and sentence representation of each message;
storing the extracted sentences of question, asking back, reply, and answer in association with each other;
in response to a new question, searching a plurality of sets of the sentences of question, asking back, reply, and answer stored in the past for a set similar to a sentence of the new question; and
displaying a search result on the display in a manner that the sentences of question, asking back, reply, and answer are associated with the set similar to the sentence of the new question.
